(19) United States
(12) Patent Application Publication
(10) Pub. No.: US 2009/0079549 A1
(43) Pub. Date: Mar. 26, 2009

(54) DEVICE AND SYSTEM FOR PATIENT-CARE PROVIDER COMMUNICATION

(76) Inventor: Bryant P. Ruder, Eureka, IL (US)

Correspondence Address: ADVANTIA LAW GROUP, 9035 SOUTH 1300 EAST, SUITE 200, SANDY, UT, 84094, US

(21) Appl. No.: 12/236,338

(22) Filed: Sep. 23, 2008

Related U.S. Application Data
(60) Provisional application No. 60/974,693, filed on Sep. 24, 2007.

(51) Int. Cl. G08B 5/22

(52) U.S. Cl. 340/286.07

(57) ABSTRACT

An electronic identification badge configured to provide patient-care provider communication, comprising a clip and a housing. The housing includes a master image display device; wherein the master display module further includes a first pocket disposed on the front side of the housing. The badge also includes a manual signal module having a call button module and an image display device, wherein the image display device further includes a second pocket. The badge further includes a signal module functionally coupled to the manual signal module and configured to transmit a wireless signal triggered. The signal module includes a control module, wherein the control module further includes a plurality of buttons. The signal module also includes a network communication module, wherein the network communication module further includes a wireless transmission module. In addition, the signal module includes a data storage module and a light module in communication with the control module.

### CROSS-REFERENCE TO RELATED APPLICATIONS

This invention claims priority, under 35 U.S.C. §120, to the U.S. Provisional Patent Application No. 60/974,693 to Ruder filed on Sep. 24, 2007, which is incorporated by reference herein.

### BACKGROUND OF THE INVENTION

1. Field of the Invention

The present invention relates to communication systems, specifically to an electronic identification badge configured to provide patient-care provider communication.

2. Description of the Related Art

Emergency communication systems have been used to contact and alert care providers of an emergency situation. These systems are typically found in a hospital, or an elderly home, where the emergency communication systems have saved thousands of lives by alerting care providers of an emergency situation that needed immediate attention. The majority of the communication systems are configured to be coupled to a hospital room, or to the side of a hospital bed. Unfortunately, patients are not always next to their hospital room, bed, or the communication system itself; in addition, some patients have illnesses or disabilities that make performing simple movement difficult including using the communication system. Some improvements have been made in this field. Examples of references related to the present invention are described below, and the supported teachings of each reference are incorporated by reference herein:

U.S. Pat. No. 5,673,016, issued to Lutes, discloses a multifunction visitor information system for use in association with a building structure including an electrical system, intercom system, door bell system, security system and telephone system, the apparatus comprising: a central control unit formed in a planar configuration with an essentially hollow interior, the control unit being coupleable to a desired mounting surface, the control unit including at least one light, a liquid crystal display panel including means for displaying a plurality of different messages for viewing by visitors to a building structure, the liquid crystal display panel and each light being electrically coupled to the electrical system of a building structure; and a plurality of function buttons being positioned within the display unit and operatively coupled to the liquid crystal display panel, the function buttons permitting users to send a plurality of different coded sequences to the panel thereby causing different messages to be displayed on the panel.

U.S. Patent Publication 2003/0092453, by Mills et al., discloses a remote wireless intercom and other devices for communicating with a cordless telephone system are disclosed. The remote wireless intercom includes a transmitter, a receiver, a speaker, a microphone, a battery interface, and a housing which carries these components. A method of communicating between the remote wireless intercom and a cordless telephone device involves the steps of detecting an intercom voice communication request at the remote wireless intercom; wirelessly transmitting the intercom voice communication request from the remote wireless intercom to the a cordless telephone device; and engaging the remote wireless intercom in an intercom voice communication session with the cordless telephone device after transmitting the intercom voice communication request. Preferably, the cordless telephone device is a cordless base station and the intercom voice communication session takes place between the remote wireless intercom and a cordless telephone. A unique intercom alert is provided at the cordless telephone device when the intercom voice communication request is received.

U.S. Pat. No. 6,397,054, issued to Hoirup et al., discloses a method for communicating emergency messages using non-voice connections. An emergency short message service is added to digital wireless standards, such as GSM-based standards. This service allows users to place an emergency call with the specific purpose of sending an emergency data message using Short Message Service (SMS). Such data messages might include the caller's geographical position, electronic mail messages, or possibly, diagnostic information. As a result, the emergency data messaging will be given the same access conditions as voice emergency calls in a cellular or satellite communications system.

The inventions heretofore known suffer from a number of disadvantages which include being difficult to use, being limited in application, being limited in versatility, being bulky, being expensive, being limited in adaptability, and being ineffective.

What is needed is a communication system that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available communication systems. Accordingly, the present invention has been developed to provide an efficient and effective communication system.

In one embodiment of the invention, there is an electronic identification badge configured to provide patient-care provider communication that may comprise a clip. The clip may be configured to couple to a user's clothing. The badge may also include a housing, wherein the housing may be coupled to the clip. The housing may include a master image display device functionally coupled to a front side of the housing, opposite of the clip. The master display module may further include a first pocket disposed on the front side of the housing having a first transparent window, wherein the first pocket may be configured to secure and store patient identification information. The housing may also include a manual signal module, coupled to the housing, wherein the manual signal module may comprise a call button module configured to enable a user to actuate a physical trigger and thereby transmit a call signal. The housing may further include an image display device adjacent the call button and configured to display information. The image display device may also include a second pocket disposed on the front side of the housing having a second transparent window, configured to secure and store patient identification information.

In addition, the badge may include a signal module functionally coupled to the manual signal module, wherein the signal module may be configured to transmit a wireless signal triggered by the manual signal module. The signal module may include a control module in communication with the manual signal module and configured to receive a call signal. The control module may include a plurality of buttons disposed on the front side of the housing, in communication with the signal module, wherein the buttons are configured to provide controls. The signal module may include a network communication module in communication with the control module, configured to transmit a wireless signal triggered by instructions from the control module. The network communication module may include a wireless transmission module, in communication with the control module, configured to wirelessly transmit patient information. Furthermore, the signal module may also include a data storage module configured to selectably store and transmit patient information. The housing may also include a light module in communication with the control module and configured to provide illumination of the badge.

Reference throughout this specification to features, advantages, or similar language does not imply that all of the features, and advantages, that may be realized with the present invention should be, or are, in any single embodiment of the invention. Rather, language referring to the features, and advantages, is understood to mean that a specific feature, advantage, or characteristic described in connection with an embodiment is included in at least one embodiment of the present invention. Thus, discussion of the features, and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features, or advantages, of a particular embodiment. In other instances, additional features, and advantages, may be recognized in certain embodiments that may not be present in all embodiments of the invention.

These features, and advantages, of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a perspective view of a communication system, according to one embodiment of the invention;

FIG. 2 is a front elevational view of an electronic identification badge, according to one embodiment of the invention;

FIG. 3 is side elevational view of an electronic identification badge, according to one embodiment of the invention; and

FIG. 4 is a block diagram of an electronic identification badge, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will, nevertheless, be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole, or in part, one with another as the claims and/or art may direct, either directly or indirectly, implicitly or explicitly.

As used herein, “comprising,” “including,” “containing,” “is,” “are,” “characterized by,” and grammatical equivalents thereof are inclusive, or open-ended terms that do not exclude additional unrecited elements or method steps. “Comprising” is to be interpreted as including the more restrictive terms “consisting of” and “consisting essentially of.”

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations, including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. As those skilled in the art will appreciate, any computers discussed herein may include an operating system (e.g., Windows Vista, NT, 95/98/2000, OS2; UNIX; Linux; Solaris; MacOS; and etc.) as well as various conventional support software and drivers typically associated with computers. The computers may be in a home, or business environment, with access to a network. In an exemplary embodiment, access is through the Internet through a commercially-available web-browser software package.

The present invention may be described herein in terms of functional block components, screen shots, user interaction, optional selections, various processing steps, and the like. Each of such described herein may be one or more modules in exemplary embodiments of the invention. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, AJAX, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript, or the like.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI, or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

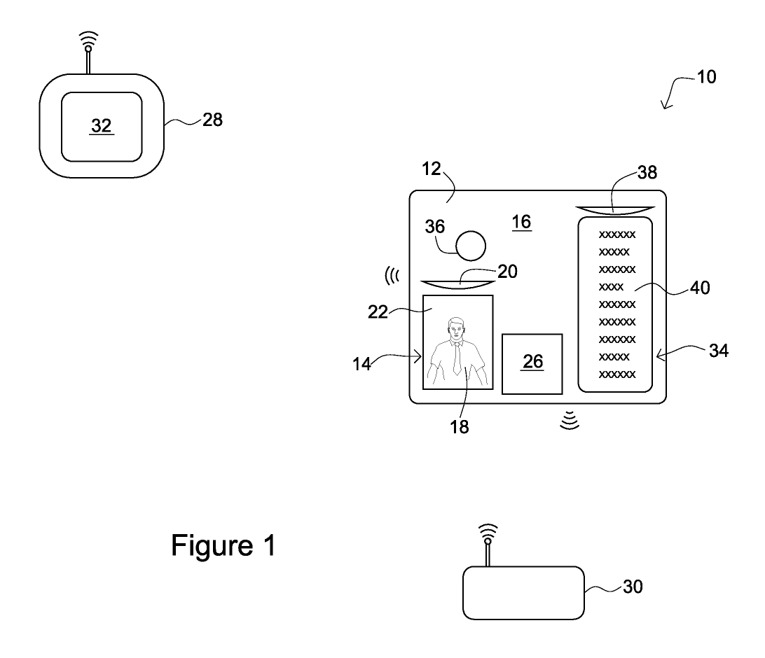

FIG. 1 illustrates an electronic identification badge 10 configured to provide patient-care provider communication, according to one embodiment of the invention, wherein the badge 10 includes a housing 12. The housing 12 comprises a master image display 14 functionally coupled to a front side of the housing 16. As illustrated in FIG. 1, the master image 14 display illustrates an image of the patient/user 18. The master image display 14 also includes a first pocket 20 disposed on the front side of the housing 16, wherein the first pocket 20 includes a first transparent window 22. The first pocket 20 is configured to secure and store patient information, wherein the first transparent window 22 is configured to enable a care provider to easily view the patient data. The badge 10 also includes a manual signal module 24, wherein the manual signal module 24 includes a call button 26. The call button 26 is configured to enable a user to actuate a physical trigger 26 and thereby transmit a call signal. As illustrated in FIG. 1, the badge 10 is configured to send a call signal to a care-provider network 28, and a care provider 32, or to a third party 30, requesting attention or assistance.

The manual signal module 24 also includes an image display device 34 adjacent the call button 26 and configured to display information. As illustrated in FIG. 1, the image display device 34 includes a second pocket 38 disposed on the front side of the housing 16, wherein the second pocket 38 includes a second transparent window 40. The second pocket 38 is configured to secure and store patient data, wherein the second transparent window 40 is configured to enable a care provider to easily view the patient information and/or provide labeling for one or more call buttons. The housing 12 also includes a light module 36, wherein the light module 36 is configured to provide illumination of the badge 10. In addition, the light module 36 is configured to indicate a status of the patient/user; wherein the light module 36 is configured to display a color, wherein the color is configured to correspond to the status of the patient/user.

In operation of one embodiment of the electronic identification badge 10, a user couples the badge 10 about the user. The user may couple the badge to an article of clothing that the user is wearing or it is envisioned that the badge 10 may be worn like a necklace about the user's neck. The user activates the physical trigger 26 of the manual signal module 24, thereby transmitting a call signal to a care provider for attention or assistance. The manual signal module 24 transmits a call signal to a care-provider network 28, and a care provider 32, or to a third party 30, requesting attention or assistance. The care provider 32 attends to the patient/user and records patient/user data from the first pocket 20 and second pocket 38 of the badge 10. The care provider 32 records the patient/user data in the care provider network 28, updating the records and the status of the patient/user.

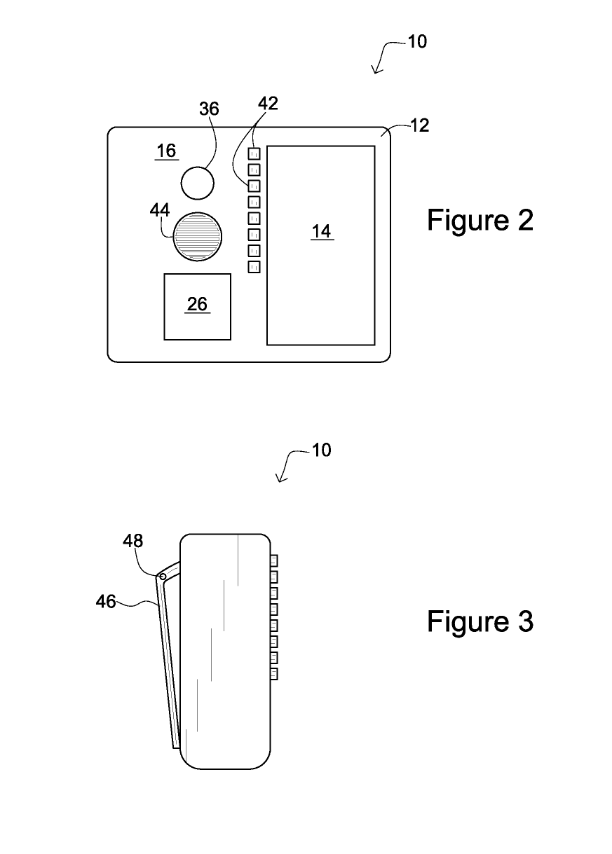

FIG. 2 illustrates an electronic identification badge 10 according to one embodiment, wherein the badge 10 includes a housing 12. The housing 12 includes a master image display 14 functionally coupled to a front side of the housing 16. As illustrated in FIG. 2, the master image display 14 is a LCD display device, configured to display patient/user data, including an image of the patient/user. One non-limiting example of a LCD display device 14 may be a Standard LCD Display Module as manufactured by Liquid Crystal Images, Inc. at 17078 Munn Road, Chagrin Falls, Ohio, 44023. FIG. 2 also illustrates a plurality of buttons 42, wherein the plurality of buttons 42 is in communication with the master image display 14. The plurality of buttons 42 are configured to provide controls to the master image display 14 and/or trigger one or more call signals. The badge 10 also includes a speaker module 44, wherein the speaker module 44 is in communication with the master image display 14 and configured to provide audio output. The badge 10 further includes a manual signal module 24 configured to enable a user to actuate a physical trigger 26 and thereby transmit a call signal. As illustrated in FIG. 2, the physical trigger 26 may be a touch sensor module, wherein the badge 10 is configured to send a call signal to a care-provider, requesting attention or assistance. The housing 12 also includes a light module 36, wherein the light module 36 is configured to provide illumination of the badge 10 and a status of the patient/user.

In operation of one embodiment of the electronic identification badge 10, a user couples the badge 10 about the user. The user may couple the badge to an article of clothing that the user is wearing, or it is envisioned that the badge 10 may be worn like a necklace about the user's neck. The user activates the physical trigger 26 of the manual signal module 24, thereby transmitting a call signal to a care provider for attention or assistance. The care provider may inform the patient/user of instructions, through the speaker module 44, before the care provider is physically there. The care provider attends to the patient/user and records patient/user data stored on the badge 10. The care provider 32 records the patient/user data by using the plurality of buttons and viewing and editing the records through the LCD display device 14. The care provider is also configured to correspond to the care provider network 28, updating the records and the status of the patient/user.

FIG. 3 illustrates an electronic identification badge 10, according to one embodiment, wherein the badge 10 includes a clip 46. As illustrated in FIG. 3, the clip 46 includes a pivot member 48, wherein the pivot member 48 is configured to secure the badge 10 to a patient/user. The clip 46 is configured to couple to an article of clothing, a pocket, or a waist area of a patient/user.

In operation of one embodiment of the electronic identification badge 10, a user couples the clip 44 about the user. The user may couple the clip 44 to an article of clothing that the user is wearing. The user activates the physical trigger 26 of the manual signal module 24, thereby transmitting a call signal to a care provider requesting attention or assistance.

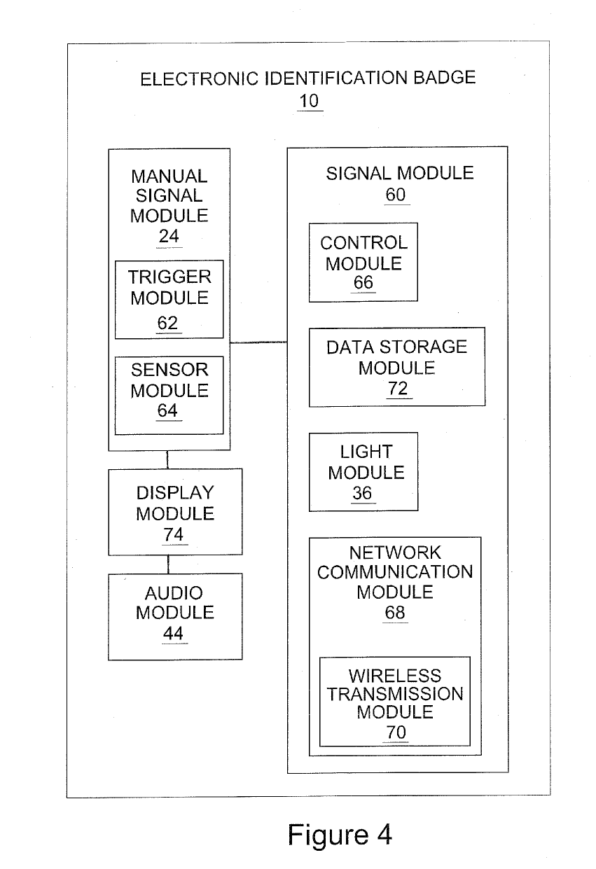

FIG. 4 illustrates an electronic identification badge 10, according to one embodiment, wherein the badge 10 includes a manual signal module 24. The manual signal module is in communication with a signal module 60 and is configured to transmit a wireless signal, triggered by the manual signal module 24. As illustrated in FIG. 4, the manual signal module 24 includes a trigger module 62, wherein the trigger module 62 initiates the manual signal module 24 to transmit a call signal. The trigger module 62 includes a sensor module 64, wherein the sensor module 64 is configured to sense pressure about the trigger module 62 thereby initiating the manual signal module 24 to send a call signal.

As illustrated in FIG. 4, the signal module 60 includes a control module 66, wherein the control module 66 is in communication with manual signal module 24. One non-limiting example of a control module may be a control module described in U.S. Pat. No. 5,673,016, issued to Lutes, which is hereby incorporated for its supported teachings. The signal module 60 also includes a network communication module 68, wherein the network communication module 68 includes a wireless transmission module 70 in communication with the control module 66, wherein the wireless transmission module 70 is configured to transmit a wireless signal triggered by instructions from the control module 66. One non-limiting example of a network communication module including a wireless transmission module may be a remote wireless intercom as described by U.S. Patent Publication 2003/0092453, issued to Mills et al. The signal module 60 further includes a light module 36, wherein the light module 36 is in communication with the control module 66 and configured to provide illumination of the badge 10 and a status of the patient/user. Also illustrated in FIG. 4, the signal module 60 includes a data storage module 72, wherein the data storage module 72 is configured to selectably store and transmit patient/user information. In addition, the badge 10 includes a display module 74 in communication with the control module 66, wherein the display module 74 is configured to display patient/user data. One non-limiting example of a display module may be, a LCD panel described in U.S. Pat. No. 5,673,016, issued to Lutes, which is hereby incorporated for its supported teachings. Furthermore, the badge 10 also includes a speaker module 44, wherein the speaker module 44 is in communication with the display module 74 and the control module 66. The speaker module 44 is configured to provide audio input and output.

In operation of one embodiment of the electronic identification badge 10, a user activates the physical trigger 26 of the manual signal module 24, thereby transmitting a call signal to a care provider for attention or assistance. The manual signal module 24 transmits a call signal to the signal module 60, wherein the signal module 60 incorporates a unique patient/user identification with the call signal and then transmits the information to a care-provider network 28, and a care provider 32, or to a third party 30, requesting attention or assistance. The unique patient/user identification validates the information being sent from the badge to the care provider or third party. The unique patient/user identification may also include patient/user records, address, and other important patient/user information.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the Figures illustrate an electronic identification badge in a square shaped housing, one skilled in the art would appreciate that the housing may vary in size, shape, design, configuration, length, width, color, and components and still perform its intended function.

Additionally, although the figures illustrate two separate embodiments of the electronic identification badge, one skilled in the art would appreciate that the components of the two embodiments may be incorporated into one embodiment. It is envisioned that the badge without the LCD display device may also include a plurality of buttons configured to correspond to a function related to patient-care provider communication and still perform its intended function.

It is envisioned that one skilled in the art would appreciate that a care provider may be a care provider from a hospital, clinic, mental institute, pharmacy, physician's office, or any other health care provider. In addition, the care-provider may be a physician, psychiatrist, psychologist, therapist, social worker, nurse, at-home care provider, hospice care provider, nursing home care provider, and any other care provider, and still perform its intended function.

It is also envisioned that the speaker module may include an intercom module, wherein the intercom module enables the patient/user to communicate directly to a care provider. The client/user may communicate the need for assistance or the description of the current situation, or client/user status, wherein the badge still performs its intended function.

It is expected that there could be numerous variations of the design of this invention. An example is that the badge may send two separate call signals, instead of sending a call signal to either a care provider or to a third party. The badge may be configured to send a call signal to a care provider and to a third party and still perform its intended function.

Furthermore, it is envisioned that the speaker module may be in communication with the manual signal module, wherein the patient/user initiates the trigger module by a vocal command. The speaker module may be configured to detect a command and initiate a call signal to a care provider, or to a third party, and still perform its intended function.

Finally, it is envisioned that the components of the device may be constructed of a variety of materials, metal, metal alloys, plastic, glass, plastic composites, rubber, rubber composites, textiles, and still perform its intended function.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made without departing from the principles and concepts of the invention as set forth in the claims. Further, it is contemplated that an embodiment may be limited to consist of, or to consist essentially of, one or more of the features, functions, structures, or methods described herein.

What is claimed is:

1. An electronic identification badge configured to provide patient-care provider communication, comprising:
a) a clip configured to couple to a user;
b) a housing coupled to the clip, having a master image display device functionally coupled to a front side of the housing, opposite of the clip;
c) a manual signal module, coupled to the housing, comprising:
c1) a call button module configured to enable a user to actuate a physical trigger and thereby transmit a call signal; and
c2) an image display device adjacent the call button and configured to display information; and
d) a signal module functionally coupled to the manual signal module and configured to transmit a wireless signal triggered by the manual signal module, comprising:
d1) a control module in communication with the manual signal module and configured to receive a call signal;
d2) a network communication module in communication with the control module, configured to transmit a wireless signal triggered by instructions from the control module; and
d3) a light module in communication with the control module and configured to provide illumination of the badge.

2. The badge of claim 1, wherein the master display module further includes a first pocket disposed on the front side of the housing having a first transparent window, configured to secure and store patient health information.

3. The badge of claim 1, wherein the image display device further includes a second pocket disposed on the front side of the housing having a second transparent window, configured to secure and store patient identification information.

4. The badge of claim 1, wherein the signal module further includes a data storage module configured to selectably store and transmit patient information.

5. The badge of claim 1, wherein the signal module further includes a speaker module, in communication with the control module, configured to display audio patient information.

6. The badge of claim 1, wherein the network communication module further includes wireless transmission module, in communication with the control module, configured to wirelessly transmit patient information to a care-provider network.

7. The badge of claim 1, wherein the control module further includes a plurality of buttons disposed on the front side of the housing, in communication with the signal module, configured to provide controls.

8. An electronic identification badge configured to provide patient-care provider communication, comprising:
a) a clip configured to couple to a user;
b) a housing coupled to the clip, having a master image display device functionally coupled to a front side of the housing, opposite of the clip;
c) a manual signal module, coupled to the housing, comprising:
c1) a call button module configured to enable a user to actuate a physical trigger and thereby transmit a call signal; and
c2) an image display device adjacent the call button and configured to display information; and
d) a signal module functionally coupled to the manual signal module and configured to transmit a wireless signal triggered by the manual signal module, comprising:
d1) a control module in communication with the manual signal module and configured to receive a call signal;
d2) a network communication module in communication with the control module, configured to transmit a wireless signal triggered by instructions from the control module;
d3) a data storage module configured to selectably store and transmit patient information; and
d4) a light module in communication with the control module and configured to provide illumination of the badge.

9. The badge of claim 8, wherein the master display module further includes a first pocket disposed on the front side of the housing having a first transparent window, configured to secure and store patient health information.

10. The badge of claim 9, wherein the image display device further includes a second pocket disposed on the front side of the housing having a second transparent window, configured to secure and store patient identification information.

11. The badge of claim 10, wherein the signal module further includes a speaker module, in communication with the control module, configured to display audio patient information.

12. The badge of claim 11, wherein the network communication module further includes a wireless transmission module, in communication with the control module, configured to wirelessly transmit patient information to a care-provider network.

13. The badge of claim 12, wherein the control module further includes a plurality of buttons disposed on the front side of the housing, in communication with the signal module, configured to provide controls.

14. An electronic identification badge configured to provide patient-care provider communication, comprising:
a) a clip configured to couple to a user;
b) a housing coupled to the clip, having a master image display device functionally coupled to a front side of the housing, opposite of the clip; wherein the master display module further includes a first pocket disposed on the front side of the housing having a first transparent window, configured to secure and store patient identification information;
c) a manual signal module, coupled to the housing, comprising:
c1) a call button module configured to enable a user to actuate a physical trigger and thereby transmit a call signal; and
c2) an image display device adjacent the call button and configured to display information; wherein the image display device further includes a second pocket disposed on the front side of the housing having a second transparent window, configured to secure and store patient identification information; and
d) a signal module functionally coupled to the manual signal module and configured to transmit a wireless signal triggered by the manual signal module, comprising:
d1) a control module in communication with the manual signal module and configured to receive a call signal; wherein the control module further includes a plurality of buttons disposed on the front side of the housing, in communication with the signal module, configured to provide controls;
d2) a network communication module in communication with the control module, configured to transmit a wireless signal triggered by instructions from the control module; wherein the wireless transmission module further includes a wireless transmission module, in communication with the control module, configured to wirelessly transmit patient information;
d3) a data storage module configured to selectably store and transmit patient information; and
d4) a light module in communication with the control module and configured to provide illumination of the badge.
